(19) United States
(12) Patent Application Publication
(10) Pub. No.: US 2013/0231415 A1
(43) Pub. Date: Sep. 5, 2013

(54) Slump Retaining and Dispersing Agent for Hydraulic Compositions

(71) Applicant: RUETGERS POLYMERS LTD., Candiac (CA)

(72) Inventors: Monique PAGE, Brossard (CA); Anthony LIPPL, Carignan (CA); Iordana TRIANTAFILLU, Brossard (CA); Yves DENOMME, La Prairie (CA); Xiaofu ZHANG, Greenfield Park (CA); Genevieve CORBEIL, Delson (CA); Mario DUPUIS, Greenfield Park (CA); Pascal CABANA, La Prairie (CA)

(73) Assignee: RUETGERS POLYMERS LTD., Candiac (CA)

(21) Appl. No.: 13/756,842

(22) Filed: Feb. 1, 2013

Related U.S. Application Data
(60) Provisional application No. 61/606,667, filed on Mar. 5, 2012.

(51) Int. Cl. C04B 24/26; C08F 220/56

(52) U.S. Cl. CPC C04B 24/2688; C08F 220/56
USPC 523/130; 526/240; 524/547; 524/160; 524/3

(57) ABSTRACT

The invention relates to copolymers effective as slump retention agents for hydraulic compositions such as cement, mortar and concrete. The copolymers are formed by reacting monomers A, B and C, wherein monomer A is a compound of formula I, monomer B is a compound of formula II, and monomer C is a compound of formula III or IV as shown herein. The copolymers may be used alone or in combination with a water reducing agent or slump retaining agent, e.g. a superplasticizer such as PNS or PMS or a low range water reducer such as lignosulfonate. The copolymer includes a group that is hydrolyzable at elevated pH (e.g. around pH 12) typically present in hydraulic compositions, so that the group hydrolyzes when present in such compositions and forms a charged group that provides extended slump retention properties without introducing undesirable air-entraining characteristics.

### CROSS-REFERENCE TO RELATED APPLICATIONS

This application claims the priority right of prior co-pending U.S. Provisional Patent Application Ser. No. 61/606,667 filed on Mar. 5, 2012 by applicants named herein. The entire contents of Application Ser. No. 61/606,667 are incorporated herein by this reference.

### BACKGROUND OF THE INVENTION

1. Field of the Invention

The present invention relates slump retaining agents and dispersing agents for hydraulic compositions. More particularly, the invention relates to such agents capable of modifying the fluidity or slump characteristics of hydraulic powders and hydraulic compositions.

2. Background Art

Various additives and admixtures have been added to hydraulic compositions to improve the properties of fresh and/or cured preparations. Among those additives and admixtures, superplasticizers are now broadly recognized as essentials components of high performance concrete and other hydraulic compositions. Introduced to the concrete industry in the early 1970s, superplasticizers have since then been part of every major High Performance Concrete project in a variety of applications including high-rise buildings, stadiums, bridges, oil-drilling platforms, etc. For the most part, these projects were completed using what are now referred to as conventional superplasticizers, namely naphthalenesulfonic acid-formaldehyde condensates (PNS) and melaminesulfonic acid-formaldehyde condensates (PMS). Although these conventional superplasticizers provide appropriate water reduction and overall adequate fresh concrete properties (typically slump, air void parameters and stability, setting, bleeding and segregation), they strongly interact with hydrating cement particles, thus reducing their capacity to maintain slump over time^{[1]} (Note that the numbers in superscript used throughout this description refer to the articles and patents itemized under the same numbers in the REFERENCES section provided at the end of this description).

Concrete producers have to deal on a daily basis with slump loss of concrete. Most of the time, concrete has to be adjusted at the construction site to ensure that it can be placed and compacted properly. Several methods have been tried over time to maintain good workability of the concrete, including: i) production of concrete with very high initial slump, or ii) retempering of concrete with water and/or with superplasticizers or water reducers at the job site. However, these methods increase complexity for the user, add cost related to manpower, increase the risk of over dosage and generally decrease the performance of concrete.

During the last decade, polycarboxylate acrylic ester (PAE) and polycarboxylate ether (PCE) copolymers were developed and proposed as concrete superplasticizers. This new class of dispersants exhibits much higher water reduction than conventional superplasticizers (PNS or PMS); their slump retention behavior is also significantly better^{[1-7]}. However, due to the inherent air-entraining character of these superplasticizers, suitable air void parameters and air void stability are often more difficult to achieve in the presence of PAE than in the presence of PNS or PMS.

Various approaches have been pursued to improve the performance of PNS with respect to water reduction, and particularly with respect to slump retention to obtain performance similar to that obtained with PAE. Such approaches included addition of other water-reducing set retarding agents or admixtures, typically lignosulfonate or gluconate salts. To minimize the set-retarding effect of PNS-lignosulfonates mixtures, blends of PNS and ultra-filtered lignosulfonates were proposed to achieve adequate slump retention with minimal set retardation^{[8]}. The approach has apparently not been widely adopted in industrial practice, perhaps due to the poor availability and high end user cost of the treated lignosulfonates.

Various copolymerization approaches, e.g. combining PNS or PMS with other functional monomers, have also been pursued^{[9-12]}. The resulting products have exhibited some performance improvements compared to PNS-only or PMS-only polymers, but the gains are insufficient to support large scale acceptance and use.

Blending PNS with polycarboxylate acrylic ester (PAE) copolymers has also been proposed to provide extended fluidity retention with PNS. For example, US patent publication No. US 2011/0098387 A1 describes a blend of PNS with an acrylic polymer containing at least 70% by weight of hydroxyethyl acrylate. Also, U.S. Pat. No. 4,791,360 describes a polymer of a hydroxyalkyl(meth)acrylate or a copolymer thereof with another hydroxyalkyl(methacrylate) or sulfoethyl methacrylate. Furthermore, European Patent No. EP 0 303 747 B1 describes a copolymer with an ethylenic unsaturated acid monomer and a hydroxyl (C₂-C₃) alkyl ester of an ethylenically unsaturated acid monomer. However, all the polymers described in the above publications and patents have the same side effect, i.e. they entrain undesired air in the hydraulic composition. To date, such products do not appear to have achieved significant industrial application, although some are reported to yield significant benefits.

More recently, new versions of polycarboxylate acrylic ester (PAE) copolymers with extended workability have been disclosed in US patent publications nos. US 2010/0113651 A1, US 2011/0054083 A1 and US 2011/0166261 A1. The extended workability of these new PAEs is based by the addition of an ethylenically unsaturated monomer comprising a moiety that can be hydrolysed at high pH. Once hydrolyzed, this monomer generates an additional active binding site that allows the adsorption of the polymer onto cement grains and thus maintains desirable slump values over a longer period of time.

However, due to the inherent air-entraining character of these polycarboxylate superplasticizers, there is a need to blend them with a defoaming system to ensure a controlled air content of the hydraulic composition. One of the drawbacks of the defoaming system is the difficulty to assure the long term stability of the blended admixture. Many solutions have been proposed to solve this problem. For example, U.S. Pat. No. 6,875,801 B2 describes a system based on a water-insoluble defoamer blend with an amine solubilising agent to stabilize the water insoluble defoamer. Additionally, U.S. Pat. No. 6,858,661 B2 describes a tertiary amine defoamer with a molecular weight of 200-750, such as dodecyldimethlyamine. Although these defoaming systems can control air content in some circumstances, the polycarboxylate ether (PCE) superplasticizers remain as a “non robust” solution for the preparation of air-entrained concrete showing high sensitivity to cement composition, dosage sensitivity of the air entraining agent, sensitivity to mixing time and mixing energy, and unstable air content during re-temperation at the job site.

Thus, although the acrylic additive for PNS or polycarboxylate copolymers with or without hydrolysable ethylenically monomers may provide extended workability retention of hydraulic composition, the air entrainment side effect obtain with these admixtures remains a major problem.

In spite of these different solutions that have been proposed to the concrete industry, there is still a need for an admixture giving extended slump retention but without air entrainment problems and that will also show a very low sensitivity to variation of the chemical compositions of concrete materials as well as variations of concrete preparation parameters.

### SUMMARY OF THE EXEMPLARY EMBODIMENTS

Exemplary embodiments of the present invention relate to extended slump retention copolymers for hydraulic compositions with low or no air entraining effects. These polymers, at least in exemplary forms, may be blended with other water reducers or superplasticizers (PNS for example) or added separately to hydraulic compositions as a workability-retaining admixture. Exemplary forms of this blend of polymers may provide a flexible degree of slump retention by adjusting the formulation of the blend. Unlike current polycarboxylates used in the concrete industry or other acrylic additives for PNS, exemplary forms of this new polymer have low or no air entraining side effects and, at least in exemplary embodiments, can be used without causing air entrainment, excessive retardation or prevention of setting of the treated compositions.

The polymers of the exemplary embodiments may be obtained by copolymerization of the following monomers:
I. Monomer A: An unsaturated monocarboxylic acid such as acrylic acid, methacrylic acid, crotonic acid; a unsaturated dicarboxylic monomer such as maleic, itaconic, fumaric (in anhydride or acid form); or a phosphorus-containing monomer ethyleneglycol methacrylate phosphate ester. The monomer A may be a mixture of two or more of such monomers. Monomer A may be represented by the general formula I below:

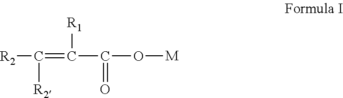

wherein R¹ is H or CH₃ or CₙH₂ₙX; X is COOH, PO₃H₂, SO₃H and their alkali salts. R₂ is H or an alkyl group (e.g. straight chain or branched chain C₁-C₆ alkyl groups); R₂′ is H or COOH or is an alkali salt of COOH; and M is H, ½ Ca, Na or other alkalis, or CₙH₂ₙY in which n=1-4 and Y is selected from OH, COOH, PO₃H₂, SO₃H and their alkali salts.
II. Monomer B: An ethylenic-unsaturated monomer comprising a moiety hydrolysable at high pH (e.g. at about pH 12 or higher often encountered in hydraulic mixes) wherein the ethylenic-unsaturated monomer residue, when hydrolyzed, comprises an active binding site. The monomer B may be a mixture of two or more such monomers. Monomer B is represented by formula II below:

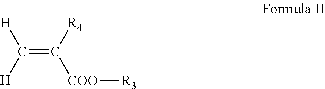

wherein R₃ represents an alkyl group (e.g. straight chain or branched chain C₁-C₆ alkyl groups), or (CₙH₂ₙO)ₘH wherein n=1 to 4, m=1 to 6 and R₄ is H or CH₃.
III. Monomer C: Monomer C is represented by formula III or formula IV below:

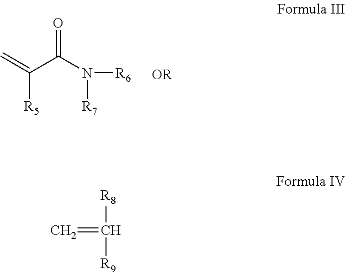

wherein:
R₅ is H or CH₃,
R₆ is H; CₙH₂ₙ₊₁, wherein n=1-8,
R₇ is H, CₙH₂ₙ₊₁ wherein n=1-8, or CₙH₂ₙX wherein n=1-4 and X is OH, COOH, PO₃H₂ or SO₃H or their alkali salts or CₙH2ₙ₋₁XX′ wherein n=1-4, X is OH, COOH, PO₃H₂ or SO₃H or their alkali salts, and X′ is OH, COOH, PO₃H₂ or SO₃H or their alkali salts,
R₈ is H; or alkyl, and
R₉ is CO(CH₂)ₙY wherein n=1-5; or (CH₂)ₙY or C₆H₄Y wherein Y is SO₃H; PO₃H₂ or their alkali salts.

The copolymer of the exemplary embodiments is preferably prepared as an admixture with a superplasticizer, such as PNS or PMS, or as an admixture with low range water reducing agent such as lignosulfonates or is added separately but in combination with a superplasticizer. The superplasticizeror water reducing agent is effective to provide initial slump (good dispersion of cement, or other binder, particles) and then, over time, slump retention is extended by the exemplary copolymer as the residue of monomer B in the copolymer hydrolyzes in the high pH conditions present in hydraulic compositions. The hydrolyzed residue is charged and provides long-term dispersion of cement (or other binder) particles, thus providing slump extension properties.

The exemplary copolymer, or its blend with a superplasticizer or low range water reducing agent, may be used in amounts substantially the same as those required for conventional superplasticizers alone.

If the terms A, B and C represent the percentage by weight of each monomer described previously, the copolymer of one exemplary embodiment is made in order to have A+B+C=100. In this case, A comprises between 10 and 50% by weight, B between 10 and 75% by weight and C between 10 and 50% by weight of the copolymer.

Other exemplary embodiments of the invention relate to copolymers effective as a dispersing agent for hydraulic compositions. The copolymers are composed of three monomers: monomer A which comprises unsaturated mono- or di-carboxylic acid, monomer B which comprises ethylenic-unsaturated monomer that can be hydrolyzed or cleaved in alkaline environment and, finally, monomer C which comprises monomers with the general formula C₃H₂R₅R₆R₇NO where R₅ are H or CH₃, R₆ are H; CₙH₂ₙ₊₁, n=1-8 and R₇ are H, CₙH₂ₙ₊₁: n=1-8, or CₙH₂ₙX: n=1-4 and X is OH, COOH, PO₃H₂ or SO₃H and their alkali salt or CₙH₂ₙ₋₁XX′: n=1-4 and X is OH, COOH, PO₃H₂ or SO₃H and their alkali salt and X′ is OH, COOH, PO₃H₂ or SO₃H and their alkali salts; or the formula R₈C₂H₂R₉ where R₈ is H; or alkyl, R₉ is CO(CH₂)ₙY; n=1-5; or (CH₂)ₙY or C₆H₄Y; Y═SO₃H; PO₃H₂ and their alkali salts. The copolymers may be used in a dispersing agent composed of a blend of two polymers: the first one (I) provides the initial fluidity and the second one (II), a copolymer as defined above, provides workability retention. These two components can be blended (formulated) or added separately as workability retaining admixture.

The polymerization of the monomers can be carried out by any well known method, such as free radical polymerization in solution, bulk or emulsion or any living radical polymerization technique. Such techniques are well known to persons skilled in the art.

Any suitable polymerization solvent can be used in such methods. Examples of such solvents include water, ethyl alcohol, isopropyl alcohol, ethyl acetate, methyl ethyl ketone, and ethyl ether. In one exemplary embodiment, such solvents are selected from water, ethyl alcohol, and isopropyl alcohol.

For polymerization in water, a polymerization initiator may be used and suitable examples include the ammonium salt or an alkaline metal salt of persulfuric acid, or water-soluble azo compounds such as 2,2′-azobis(2-methylpropionamide)dihydrate. For polymerization solvents not containing water, examples of suitable polymerization initiators include peroxides, such as benzoyl peroxide or lauroyl peroxide, or aliphatic azo compounds, such as 2,2′-azobisisobutyronitrile.

Chain transfer agents have the ability to initiate chain transfer reactions. Examples of such chain transfer agent include thiol-based and halogenated hydrocarbon-based chain-transfer agents. Examples are thiol-based chain-transfer agents represented by the formula HS—R-E (wherein R represents a group derived from a hydrocarbon having 1 to 4 carbon atoms; E represents —OH, COOM-COOR′ or an —SO₃M group; M represents a hydrogen atom a mono metal, a divalent metal, an ammonium group or an organic amine group, R′ represents an alkyl group having 1 to 10 carbon atoms; and g represents an integer of 1 to 2).

Examples of the thiol-based chain-transfer agents include mercaptoethanol, thioglycerol, thioglycolic acid, 2-mercaptopropionic acid, 3-mercaptopropionic acid, octyl thioglicolate and octyl-3-mercptopropionate. Particular embodiments employ 2-mercaptoethanol or 3-mercaptopropionc acid as chain transfer agents. These may be used alone or in combination.

The temperature of the polymerization reaction is not specifically limited, but may be controlled within the range from ambient temperature (e.g. 15° C.) up to a boiling point of the particular polymerization solvent.

The copolymers of the exemplary embodiments may be used in ready-mix or precast concrete applications to provide adequate workability retention. Such copolymers may be mixed or added separately with at least of one type of water-reducing admixture which may be, but is not limited to, normal water reducing agents such as lignosulfonates and gluconate-based water reducers, polymelamine sulfonates, polynaphthalene sulfonates, polycarboxylates, polyaspartates or oligomeric dispersants. The copolymer is more preferably mixed or added separately with non-foaming water reducers such as polynaphthalene sulfonates. The copolymers of the exemplary embodiments are found to be particularly useful for use with concretes containing clay-bearing sands rather than regular sands because, unlike other superplasticizers, they retain their slump-retaining abilities in the presence of such sands.

A strength-enhancing agent may also be employed and may include, but is not limited to, tetrahydroxyethylethylenediamine, triethanolamine, diethanolamine, monoethanol-amine, triisopropanolamine,

Other commonly-used concrete additives may be mixed or added separately, e.g. an air entraining agent, drying shrinkage reducer, polysaccharide derivative, accelerator, retarding agent, corrosion inhibitor, water proofing agent, defoaming agent, foaming agent, thickener and/or viscosity modifying agent.

A copolymer of an exemplary embodiment and another water reducing additive may be added to the hydraulic composition in solid form or as liquid admixture or in an adsorbed form on a powder. When such copolymer is added separately with another water reducing agent into the hydraulic composition, the two products may be added at the same time or at different times.

The copolymers of the exemplary embodiments are preferably intended for hydraulic compositions but are not limited to such compositions. The term “hydraulic composition” comprises any cementitious system, for example cement paste, mortar or concrete. Examples of binders used in such hydraulic compositions include any kind of Portland cement, such as cement type I to type V, or any blended cements which may contain fly ash, slag, pozzolanic materials, calcium carbonate, silica fume, diatomaceous earth metakaolin, titanium dioxide or gypsum. These cement additions may be pre-blended with the cement or added separately to the hydraulic compositions. The hydraulic compositions also include geopolymers. The copolymers of the exemplary embodiments may also be used to disperse any system into liquid or powder form. Examples of such applications are as dispersant for gypsum wallboard, for calcium carbonate and pigments.

The following Examples are intended to provide further details of particular exemplary embodiments, but are not intended to limit the general scope of the present invention.

### BRIEF DESCRIPTION OF THE DRAWINGS

In the accompanying drawings,

FIG. 1 is a graph showing the results of the tests described in Example 9 below.

### EXAMPLES 1 TO 6

### Preparation & Evaluation of Copolymers

### Synthesis Example Copolymer 1

The monomers sodium 2-acrylamido-2-methylpropanesulfonate in water solution (650 g), 2-hydroxyethylacrylate (216 g), methacrylic acid (112 g) and 2-mercaptoethanol (15 g) were placed in the stock vessel as a mixture, and 86 g water was added. In another stock vessel, 18.3 g sodium persulfate was dissolved in 184.9 g water to make the initiator solution.

In a 2 liter reaction glass vessel fitted with a thermometer and a cooling condenser, 418 g of water and a certain amount of monomer mixture were added in the flask in order to obtain a monomer concentration of 15% by weight. The reactor was then heated to 83° C. The monomer mixture and the initiator solution were introduced gradually into the reactor by a metering pump. The charging times were 150 minutes and 210 minutes, respectively. The polymerization was maintained for an hour after the end of charging of the initiator, and then the product was cooled to room temperature. The polymer was then neutralized with sodium hydroxide.

### Synthesis Example Copolymer 2

The monomers potassium 3-sulfopropyl acrylate (112 g), 2-hydroxyethylacrylate (72 g), methacrylic acid (54 g) and 2-mercaptoethanol (8 g) were placed in the stock vessel as a mixture, and 580 g water was added. In another stock vessel, 6 g sodium persulfate was dissolved in 128 g water to make the initiator solution.

In a 2 liter reaction glass vessel fitted with a thermometer and a cooling condenser, 260 g of water and a certain amount of monomer mixture were added in the flask in order to obtain a monomer concentration of 24% by weight. The reactor was then heated to 80° C. The monomer mixture and the initiator solution were introduced gradually into the reactor by a metering pump. The charging times were 125 minutes and 155 minutes, respectively. The polymerization was maintained for an hour after the end of charging of the initiator, and then the product was cooled to room temperature. The polymer was then neutralized with sodium hydroxide.

### Synthesis Example Copolymer 3

The monomers sodium 4-vinylbenzene sulfonate (83 g), 2-hydroxyethylacrylate (188 g), methacrylic acid (100 g) and 2-mercaptoethanol (12 g) were placed in the stock vessel as a mixture, and 187 g water was added. In another stock vessel, 14 g sodium persulfate was dissolved in 127 g water to make the initiator solution. In a 2 liter reaction glass vessel fitted with a thermometer and a cooling condenser, 429 g of water and a certain amount of monomer mixture were added to the flask in order to obtain a monomer concentration of 20% by weight. The reactor was then heated to 75° C. The monomer mixture and the initiator solution were introduced gradually into the reactor by a metering pump. The charging times were 150 minutes and 180 minutes, respectively. The polymerization was maintained for an hour after the end of charging of the initiator, and then the product was cooled to room temperature. The polymer was neutralised with sodium hydroxide.

### Synthesis Example Copolymer 4

The monomers sodium 2-acrylamido-2-methylpropanesulfonate water solution (660 g), 2-hydroxyethylacrylate (185.5 g), methacrylic acid (151.3 g) and 2-mercaptoethanol (8 g) were placed in the stock vessel as a mixture, and 270 g water was added. In another stock vessel, 14 g sodium persulfate was dissolved in 300 g water to make an initiator solution.

In a 2 liter reaction glass vessel fitted with a thermometer and a cooling condenser, 270 g of water and a certain amount of monomer mixture were added in the flask in order to obtain a monomer concentration of 22.5% by weight. The reactor was then heated to 80° C. The monomer mixture and the initiator solution were introduced gradually into the reactor by a metering pump. The charging times were 120 minutes and 150 minutes, respectively. The polymerization was maintained for an hour after the end of charging of the initiator, and then the product was cooled to room temperature. The polymer was then neutralized with sodium hydroxide.

### Synthesis Example Copolymer 5

The monomers sodium 2-acrylamido-2-methylpropanesulfonate water solution (266 g), 2-hydroxyethylacrylate (270 g), acrylic acid (121 g), and 2-mercaptoethanol (18 g) were placed in a stock vessel as a mixture, and 260 g water was added. In another stock vessel, 20 g sodium persulfate was dissolved in 182 g water to make an initiator solution.

In a 2 liter reaction glass vessel fitted with a thermometer and a cooling condenser, 428 g of water and a certain amount of monomer mixture were added in the flask in order to obtain a monomer concentration of 15% by weight. The reactor was then heated to 80° C. The monomer mixture and the initiator solution were introduced gradually into the reactor by a metering pump. The charging times were 120 minutes and 150 minutes, respectively. The polymerization was maintained for an hour after the end of charging of the initiator, and then the product was cooled to room temperature. The polymer was then neutralized with sodium hydroxide.

### Synthesis Example Copolymer 6

The monomers potassium 3-sulfopropyl acrylate (99 g), 2-hydroxyethylacrylate (200 g), methacrylic acid (106 g) and 2-mercaptoethanol (13 g) were placed in a stock vessel as a mixture, and 220 g water was added. In another stock vessel, 15 g sodium persulfate was dissolved in 135 g water to make an initiator solution.

In a 2 liter reaction glass vessel fitted with a thermometer and a cooling condenser, 418 g of water and a certain amount of monomer mixture were added in the flask in order to obtain a monomer concentration of 25% by weight. The reactor was then heated to 80° C. The monomer mixture and the initiator solution were introduced gradually into the reactor by a metering pump. The charging times were 120 minutes and 150 minutes, respectively. The polymerization was maintained for an hour after the end of charging of the initiator, and then the product was cooled to room temperature. The polymer was then neutralized with sodium hydroxide.

### Evaluation

An evaluation of the copolymers described above (Example 1 to 6) was carried out on self-compacting mortar with a cement/water ratio of 0.40. The mortar composition was 1758 g of natural sand sieved to have particles with a maximum size of 5 mm, 816 g of cement type GU (type I) and 326 g of water. The mortar mixer was a Hobart® N50 and the composition was always mixed at speed setting #1.

The mixing procedure of the mortar was:
Mixing of ½ of water and sand for 30 sec
T=0 min 00 sec: Adding cement
T=2 min 00 sec Adding ½ water with superplasticizer
T=4 min 00 sec Stop mixing
T=5 min 00 sec Mixing until 8 min 00 sec

At the end of the mixing time, a modified slump cone having a homothetic ratio of ½ with the slump cone described by ASTM C143 was completely filled in two layers. Each layer was rammed in 15 times. The cone was then lifted and the spread of the mortar was measured. The dosage of each admixture was dosed to reach an initial spread of 260-275 mm. The slump test was repeated at 30, 60 and 90 minutes. Before each slump test, the mortar was mixed for 30 seconds. The unit weight of the mortar was measured using the cylindrical measure of 400 ml described by ASTM C185. The copolymers described above were premixed with PNS. The ratios were 90% PNS and 10% copolymer based on the active content. The blends were compared with a commercial PNS, Disal® manufactured by Ruetgers Polymers, and two commercial polycarboxylates, Adva® 140M commercialized by W.R Grace and Glenium® 3030NS from BASF Construction Chemical.

Table 1 below (in which percentages are by weight) presents the results.

TABLE 1
Performance on fresh mortar

| | | Mortar slump flow (mm) | | | | Unit |
|---|---|---|---|---|---|---|
| Commerical | Dosage | 10 | 30 | 60 | 90 | weight |
| Products | superplaticizer | min | min | min | min | kg/m³ |
| Pure PNS | 0.560% | 263 | 224 | 194 | 172 | 2245 |
| Glenium ® | 0.170% | 271 | 261 | 245 | 235 | 2253 |
| 3030 NS | | | | | | |
| Adva ® 140M | 0.120% | 260 | 230 | 209 | 202 | 2203 |
| 10% Example 1 | 0.565% | 280 | 275 | 242 | 219 | 2235 |
| 10% Example 2 | 0.560% | 282 | 275 | 262 | 220 | 2235 |
| 10% Example 3 | 0.550% | 286 | 284 | 247 | 223 | 2230 |
| 10% Example 4 | 0.545% | 280 | 278 | 240 | 209 | 2248 |
| 10% Example 5 | 0.570% | 287 | 257 | 247 | 222 | 2248 |
| 10% Example 6 | 0.590% | 283 | 297 | 273 | 247 | 2243 |

The addition of 10% of copolymers of Examples 1 to 6 into the PNS increased significantly the workability retention of the PNS without negatively affecting the air content of the mortar.

### EXAMPLES 7 AND 8

### Preparation & Evaluation of Copolymers

### Synthesis Example Copolymer 7

The monomers sodium 2-acrylamido-2-methylpropanesulfonate water solution (730 g), 2-hydroxyethylacrylate (185 g), methacrylic acid (140 g) and 2-mercaptoethanol (10 g) were placed in a stock vessel as a mixture, and 107 g water was added. In another stock vessel, 16 g sodium persulfate was dissolved in 324.4 g water to make an initiator solution.

In a 2 litre reaction glass vessel fitted with a thermometer and a cooling condenser, 291.3 g of water and a certain amount of monomer mixture were added in the flask in order to obtain a monomer concentration of 25.7% by weight. The reactor was then heated to 80° C. The monomer mixture and the initiator solution were introduced gradually into the reactor by a metering pump. The charging times were 120 minutes and 150 minutes, respectively. The polymerization was maintained for an hour after the end of charging of the initiator, and then the product was cooled to room temperature. The polymer was then neutralized with sodium hydroxide.

The evaluation of the copolymer Example 7 was done on self-compacting mortar with a cement/water ratio of 0.38. The results are shown in Table 2 (in which percentages are by weight).

The mortar composition was 1644 g of natural sand sieved to have particles with a maximum size of 5 mm, 911 g of cement type GU (type I) and 346 g of water. The mixing procedure was the same described before.

At the end of the mixing time, the modified cone described before was completely filled without any consolidation. The copolymer of Example 7 was mixed at 10%, 15% and 20% by weight with Disal® and were compared with pure Disal® and Glenium® 3030NS.

TABLE 2
Performance on fresh mortar

| | | Mortar slump flow (mm) | | | | Unit |
|---|---|---|---|---|---|---|
| Commerical | Dosage | 10 | 30 | 60 | 90 | weight |
| Products | superplaticizer | min | min | min | min | kg/m³ |
| Glenium 3030NS | 0.190% | 368 | 363 | 356 | 348 | 2273 |
| Pure PNS | 0.545% | 352 | 326 | 272 | 249 | 2278 |
| 10% Example 7 | 0.545% | 351 | 355 | 338 | 319 | 2273 |
| 15% Example 7 | 0.540% | 352 | 357 | 349 | 343 | 2263 |
| 20% Example 7 | 0.560% | 357 | 361 | 361 | 360 | 2270 |

The increase of the ratio of copolymer example 7 increases significantly the workability retention of the PNS without affecting negatively the air content of the mortar. The blend 85% PNS and 15% copolymer Example 7 gave a similar fluidity retention than Glenium® 3030NS.

### Synthesis Example Copolymer 8

The monomers sodium 2-acrylamido-2-methylpropanesulfonate water solution (275 g), 2-hydroxyethylacrylate (270 g), methacrylic acid (165 g) and 2-mercaptoethanol (13 g) were placed in a stock vessel as a mixture, and 240 g water was added. In another stock vessel, 15 g sodium persulfate was dissolved in 140 g water to make an initiator solution.

In a 2 liter reaction glass vessel fitted with a thermometer and a cooling condenser, 400 g of water and a certain amount of monomer mixture were added in the flask in order to obtain a monomer concentration of 20% by weight. The reactor was then heated to 80° C. The monomer mixture and the initiator solution were introduced gradually into the reactor by a metering pump. The charging times were 120 minutes and 150 minutes, respectively. The polymerization was maintained for an hour after the end of charging of the initiator, and then the product was cooled to room temperature. The polymer was then neutralized with sodium hydroxide.

10% by weight of copolymer Example 8 was blended with the PNS. The blend was compared to pure PNS on the same self-compacting formulation described in synthesis Example copolymer 8 on five different cements.

Table 3 below (in which percentages are by weight) presents the results.

TABLE 3
Performance on fresh mortar

| | | | Mortar slump flow (mm) | | | | Unit |
|---|---|---|---|---|---|---|---|
| | | | 10 | 30 | 60 | 90 | weight |
| Products | Cement | Dosage | min | min | min | min | kg/m³ |
| Pure PNS | *Type GU | 0.545% | 352 | 326 | 272 | 249 | 2278 |
| 10% | | 0.555% | 367 | 365 | 362 | 347 | 2275 |
| Example 8 | | | | | | | |
| Pure PNS | **Type I/II | 0.530% | 241 | 200 | 160 | 139 | 2268 |
| 10% | | 0.515% | 260 | 262 | 244 | 218 | 2288 |
| Example 8 | | | | | | | |
| Pure PNS | **Type | 0.635% | 241 | 165 | 134 | 111 | 2290 |
| 10% | II/V | 0.645% | 257 | 243 | 226 | 196 | 2303 |
| Example 8 | | | | | | | |
| Pure PNS | **Type | 0.650% | 242 | 173 | 138 | 117 | 2260 |
| 10% | I/II/V | 0.665% | 260 | 257 | 236 | 220 | 2283 |
| Example 8 | | | | | | | |

*Slump cone having a homothetic ratio of ½ with the slump cone described by the ASTM C143
**Cone according to the ASTM C230

### EXAMPLE 9

### Comparison of Effectiveness with Clay-Bearing Sands (Percentages are by Weight)

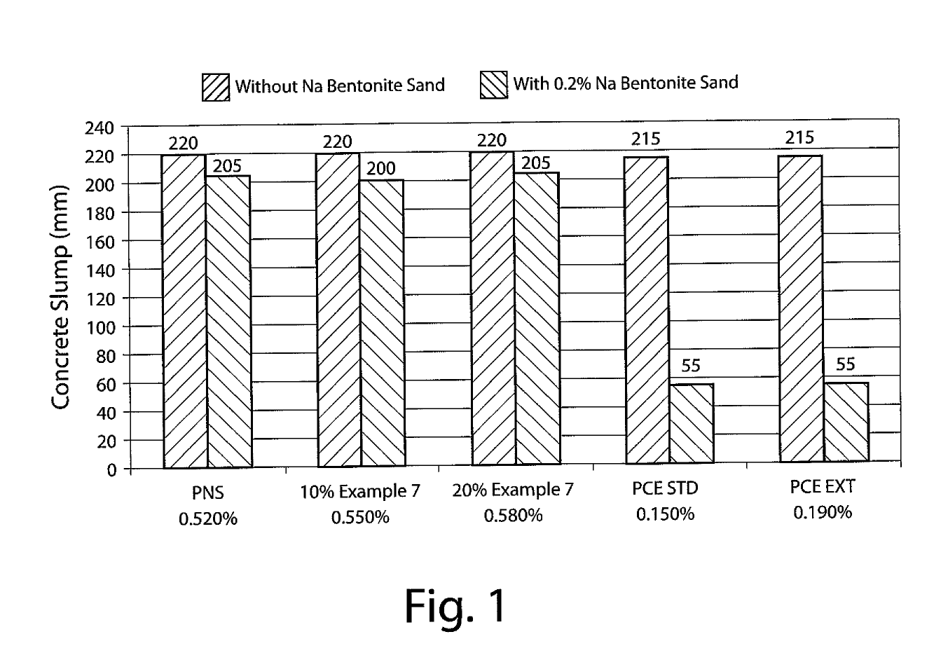

Conventional slump retaining superplasticizers often suffer a loss of effectiveness when used in hydraulic compositions containing clay-bearing sands. This Example compares the effectiveness of conventional compositions with two compositions according to the present invention identified as 10% of the copolymer of Example 7 and 20% of the copolymer of Example 7 when used in concrete mixed with regular sand or with clay-bearing sand (Na Bentonite sand). The conventional compositions were PNS, PCE Standard and PCE Extended. The results are shown in FIG. 1 of the accompanying drawings. The results show that the slump retaining performance was severely compromised in the presence of clay-bearing sand for PCE Standard and PCE Extended Slump. However, like PNS, the compositions of the invention are not significantly affected by the presence of clay-bearing sands.

While particular embodiments of the present invention have been illustrated and described, it will be apparent to those skilled in the art that various other changes and modifications may be made without departing from the spirit and scope of the invention. It is therefore intended to cover, in the appended claims, all such changes and modifications that are within the scope of this invention.

In the appended claims, the term “comprising” or any variant thereof (e.g. “comprises, comprise, etc.) means to include all of the various components, ingredients, steps, or the like, that are employed together in the practicing of the present invention without excluding the use or presence of further components, ingredients, steps, or the like. Accordingly, the term “comprising” encompasses, but is not limited to, the more restrictive terms “consisting essentially of” and “consisting of” commonly used in claim language.

### REFERENCES

[1] Spiratos, N., Pagé, M., Mailvaganam, N. P., Malhotra, V. M., Jolicoeur, C., Superplasticizers for Concrete: Fundamentals, Technology, and Practice, Supplementary Cementing Materials for Sustainable Development, Inc. Editor, Ottawa, Canada, 322 pp., 2003, Chap 14.
[2] Collepardi, M., Superplasticizers and Air Entraining Agents: State of the Art and Future Needs, Concrete Technology: Past, Present, and Future, San Francisco, U.S.A., Mehta, P. K., Editor, SP-144, pp. 399-416, 1994.
[3] Collepardi, M., Coppola, L., Cerruli, T., Ferrari, G., Pistolesi, C., Zaffaroni, P., Desroches, G. and Drapeau, A., Acrylic Based Superplasticizer, Supplementary Papers of the Fourth CANMET/ACI International Conference on Superplasticizers and Other Chemical Admixtures in Concrete, Montréal, Canada, Malhotra, V. M., Editor, pp. 1-18, 1994.
[4] Ramachandran, V. S., Malhotra, V. M., Jolicoeur, C., and Spiratos, N., Superplasticizers: Properties and Applications in Concrete, CANMET, Ottawa, 404 pp., 1998.
[5] Proceedings of the Fourth CANMET/ACI International Conference on Superplasticizers and Other Chemical Admixtures in Concrete, Montréal, Canada, Malhotra, V. M., Editor, SP-148, 455 pp., 1994.
[6] Proceedings of the Fifth CANMET/ACI International Conference on Superplasticizers and Other Chemical Admixtures in Concrete, Rome, Italy, Malhotra, V. M., Editor, SP-173, 1022 pp., 1997.
[7] Proceedings of the Sixth CANMET/ACI International Conference on Superplasticizers and Other Chemical Admixtures in Concrete, Nice, France, Malhotra, V. M., Editor, SP-195, 642 pp., 2000.
[8] U.S. Pat. No. 4,623,682, “Cement mixes and admixtures thereof”.
[9] Pagé, M., Moldovan, A., and Spiratos, N., <<Performance of Novel-Based Copolymer as Superplasticizer for Concrete>>, Proceedings of the Sixth CANMET/ACI International Conference on Superplasticizers and Other Chemical Admixtures in Concrete, Nice, France, Malhotra, V. M., Editor, SP 195-37, pp. 615-637, 2000.
[10] U.S. Pat. No. 4,759,802, <<Cement dispersing agent>>.
[11] U.S. Pat. No. 5,651,817, <<Cement dispersing agent>>.
[12] WIPO PCT Publication 75208 A1: <<Cement superplasticizer>>.

What is claimed is:

1. A copolymer effective as a slump retaining agent for hydraulic compositions, said copolymer formed by reacting monomers A, B and C, wherein:
monomer A is a compound of formula I below: 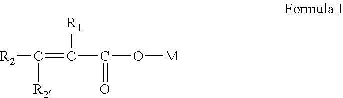
in which R₁ is H or CH₃ or CnH₂nX; X is COOH, PO₃H₂, SO₃H and their alkali salts; R₂ is H or other alkyl group; R₂′ is H or COOH or is an alkali salt of COOH; and M is H, ½ Ca, Na or other alkalis, or CₙH₂ₙY in which n=1-4 and Y is selected from OH, COOH, PO₃H₂, SO₃H and their alkali salts;
monomer B is a compound of formula II below: 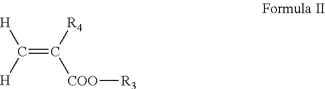
in which R₃ is alkyl (C₁-C₆), or (CₙH₂ₙO)ₘH wherein n=1 to 4, m=1 to 6 and R₄ is H or CH₃; and
monomer C is a compound of formula III or formula IV below: 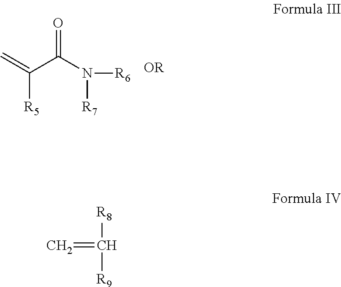
in which:
R₅ is H or CH₃,
R₆ is H; CₙH₂ₙ₊₁, wherein n=1-8,
R₇ is H, CₙH₂ₙ₊₁ wherein n=1-8, or CₙH₂ₙX wherein n=1-4 and X is OH, COOH, PO₃H₂ or SO₃H or their alkali salts or CₙH2ₙ₋₁XX′ wherein n=1-4, X is OH, COOH, PO₃H₂ or SO₃H or their alkali salts, and X′ is OH, COOH, PO₃H₂ or SO₃H or their alkali salts,
R₈ is H; or alkyl(C₁-C₆), and
R₉ is COO(CH₂)ₙY wherein n=1-5; or (CH₂)ₙY or C₆H₄Y wherein Y is SO₃H, PO₃H₂ or their alkali salts.

2. The copolymer of claim 1, wherein monomer A is one or more compounds selected from the group consisting of an unsaturated monocarboxylic acid, an unsaturated dicarboxylic monomer, a phosphorus-containing or sulfonic-containing monomer, and salts thereof;

3. The compound of claim 1, wherein monomer B is one or more ethylenically unsaturated monomers comprising a moiety hydrolysable at high pH.

4. The copolymer of claim 1, wherein monomer C is at least one compound selected from the group consisting of acrylamide, methylacrylamide, N,N-alkylmethacrylamide, N,N-alkyl acrylamide, alkyl acrylamide and alkylmethacrylamide modified monomers with mono- or di-functional groups such as carboxylic acid, phosphonic acid, sulfonic acid, sulphuric acid and their salt, or modified monomer with mono- or dihydroxyl groups, sulfopropylacrylate acid and styrene sulfonic acid and their salts.

5. The copolymer of claim 1, wherein said monomers A, B and C are reacted together such that residues of said monomers are present in the copolymer in weight ratios of 10-50%, 10-75% and 10-50%, respectively.

6. The copolymer of claim 1, wherein monomer A is an unsaturated monocarboxylic acid selected from the group consisting of methacrylic acid, itaconic acid and acrylic acid.

7. The copolymer of claim 1, wherein monomer B is an ethylenically unsaturated monomer comprising a moiety hydrolysable at high pH selected from the group consisting of 2-hydroxyethyl acrylate, and polytethyleneglycol(meth)acrylate (ethyleneglycol unit is 1-6).

8. The copolymer of claim 1, wherein said monomer C is selected from the group consisting of 2-acrylamido-2-methylpropanesulfonic acid and a salt thereof, acrylamide, methacrylamide, and 3-sulfopropylacrylic acid, styrene sulfonic acid and a salt thereof.

9. The copolymer of claim 1 produced by a method selected from the group consisting of free radical polymerization in solution, bulk polymerization, emulsion polymerization and living radical polymerization.

10. A slump retaining composition for hydraulic mixtures, comprising a copolymer according to claim 1 and a water reducing agent.

11. The slump retaining composition of claim 10, wherein the water reducing agent is selected from the group consisting of PNS, PMS, a lignosulfonate, a polycarboxylate, a gluconate-based water reducer, a polymelamine sulfonate, a polynaphthalene sulfonate, a polyaspartate, an oligomeric dispersant, and mixtures thereof.

12. A method of preparing a hydraulic composition, which comprises mixing ingredients effective for such composition together with a copolymer according to claim 1.

13. The method of claim 12, wherein said ingredients comprise a binder and water.

14. The method of claim 13, wherein said binder is Portland cement.

15. The method of claim 12, wherein said ingredients additionally include one or more additives selected from the group consisting of fly ash, slag, pozzolanic materials, calcium carbonate, silica fume, diatomaceous earth, metakaolin, titanium dioxide and gypsum.

16. The method of claim 12, wherein said ingredients are also mixed with a water reducing agent.

17. The method of claim 16, wherein said water reducing agent and said copolymer are mixed together before said mixing with said ingredients.

18. The method of claim 12, wherein said ingredients include a clay-bearing sand.

19. A dry pre-mix for a hydraulic composition comprising a binder and a copolymer according to claim 1.

20. The pre-mix of claim 19 also including a water reducing agent.

21. A mixed hydraulic composition ready for use, which comprises a binder, water and a copolymer according to claim 1.

22. The mixed hydraulic composition of claim 21, which also contains a water reducing agent.

23. Use of the copolymer of claim 1 as a slump retaining agent for a hydraulic composition comprising cement paste, mortar or concrete as a binder.

24. The use of claim 23, wherein the hydraulic composition is formulated for use in the concrete or oil well cementing industries.

25. Use of the copolymer of claim 1 as a dispersant for a liquid or powder.

26. The use of claim 25, wherein the liquid or powder is selected from the group consisting of gypsum for wallboard, calcium carbonate and pigments.

27. Use of a copolymer according to claim 1 as a dispersant for a compound selected from the group consisting of gypsum, hemihydrates, calcium carbonate and other mineral powders.

28. A method of producing a copolymer effective as a slump reducing agent for hydraulic compositions, which method comprises copolymerizing together a monomer A, a monomer B and a monomer C, wherein:
monomer A is a compound of formula I below: 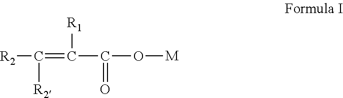
in which R₁ is H or CH₃ or CnH₂nX; X is COOH, PO₃H₂, SO₃H and their alkali salts; R₂ is H or other alkyl group; R₂′ is H or COOH or is an alkali salt of COOH; and M is H, ½ Ca, Na or other alkalis, or CₙH₂ₙY in which n=1-4 and Y is selected from OH, COOH, PO₃H₂, SO₃H and their alkali salts;
monomer B is a compound of formula II below: 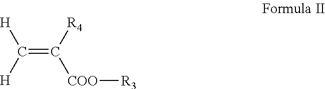
in which R₃ is alkyl (C₁-C₆), or (CₙH₂ₙO)ₘH wherein n=1 to 4, m=1 to 6 and R₄ is H or CH₃; and
monomer C is a compound of formula III or formula IV below: 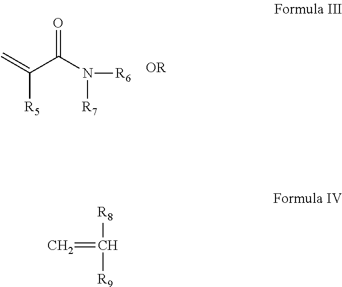
in which:
R₅ is H or CH₃,
R₆ is H; CₙH₂ₙ₊₁, wherein n=1-8,
R₇ is H, CₙH₂ₙ₊₁ wherein n=1-8, or CₙH₂ₙX wherein n=1-4 and X is OH, COOH, PO₃H₂ or SO₃H or their alkali salts or CₙH2ₙ₋₁XX′ wherein n=1-4, X is OH, COOH, PO₃H₂ or SO₃H or their alkali salts, and X′ is OH, COOH, PO₃H₂ or SO₃H or their alkali salts,
R₈ is H; or alkyl(C₁-C₆), and
R₉ is COO(CH₂)ₙY wherein n=1-5; or (CH₂)ₙY or C₆H₄Y wherein Y is SO₃H, PO₃H₂ or their alkali salts.

29. The method of claim 28, wherein said copolymerizing is carried out by a method selected from the group consisting of free radical polymerization in solution, bulk or emulsion, and a living radical polymerization technique.
